(19) United States
(12) Patent Application Publication
(10) Pub. No.: US 2026/0370271 A1
(43) Pub. Date: Nov. 19, 2026

(54) METHOD OF WIRELESS COMMUNICATION AND USER EQUIPMENT

(71) Applicant: MEDIATEK INC., Hsinchu City (TW)

(72) Inventors: Li-Cheng LIN, Hsinchu City (TW); Hannu Mikael VESALA, Oulu (FI); Tsang-Wei YU, Hsinchu City (TW)

(21) Appl. No.: 19/155,303

(22) PCT Filed: Feb. 5, 2024
(86) PCT No.: PCT/CN2024/075980

§ 371 Date: Aug. 11, 2025

Related U.S. Application Data
(60) Provisional application No. 63/485,272, filed on Feb. 16, 2023.

(51) Int. Cl. H04B 7/0452

(52) U.S. Cl. CPC H04B 7/0452

(57) ABSTRACT

A method of wireless communication is provided. The method includes using a UE to determine that the UE supports a MU-MIMO R-ML receiver. The method also includes transmitting a message to a base station. The message indicates that the UE supports the MU-MIMO R-ML receiver.

### CROSS REFERENCE TO RELATED APPLICATIONS

This application claims priority to U.S. Provisional Application Ser. No. 63/485,272, filed on Feb. 16, 2023, the entirety of which is incorporated by reference herein.

### BACKGROUND OF THE INVENTION

### Field of the Invention

The present invention relates to wireless communication, and, in particular, to wireless communication applying multi-user multiple-input multiple-output reduced-complexity maximum-likelihood receiver.

### Description of the Related Art

Multiple-input multiple-output (MIMO) systems use a communication method requiring multiple antennas. By using multiple antennas, MIMO can achieve spatial multiplexing and/or beamforming, thereby improving the total throughput of the system. On the other hand, multi-user MIMO (MU-MIMO) refers to performing the MIMO for more than two UEs simultaneously. Generally speaking, in a MU-MIMO scheme, the transmitter transmits a signal to multiple users in a MIMO manner at the same time and on the same frequency. A UE with a MU-MIMO reduced complexity maximum likelihood (R-ML) receiver needs information about the co-scheduled UEs to demodulate the signal that was transmitted from the base station in the MU-MIMO manner.

Some UEs are able to detect information about the co-scheduled UEs, but other UEs may not be able to detect this information. However, the base station is unable to as-certain the capabilities of each UE. Thus, the base station cannot be sure whether it is necessary to provide information about the co-scheduled UE to a particular UE. Providing such information to every UE by default is a waste of downlink resources.

Thus, current communication schemes can still be improved.

### BRIEF SUMMARY OF THE INVENTION

An embodiment of the present invention provides a method of wireless communication. According to the method, a unit of user equipment (UE) determines that the UE can support a multi-user multiple-input multiple-output (MU-MIMO) reduced complexity maximum likelihood (R-ML) receiver. The method also includes transmitting a message to a base station. The message indicates that the UE supports the MU-MIMO R-ML receiver.

An embodiment of the present invention provides a UE. The UE includes a processor and a transceiver. The processor is configured to determine that the UE supports a MU-MIMO R-ML receiver. The processor is also configured to transmit a message to a base station through the transceiver. The message indicates that the UE supports the MU-MIMO R-ML receiver.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a communication system in accordance to embodiments of the present disclosure;

FIG. 2 shows a block diagram of a base station and a UE according to the embodiments of the present disclosure;

FIG. 3 shows a flow diagram of a method of wireless communication in accordance to the embodiments of the present disclosure; and

FIG. 4 shows a flow diagram of a method of wireless communication in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

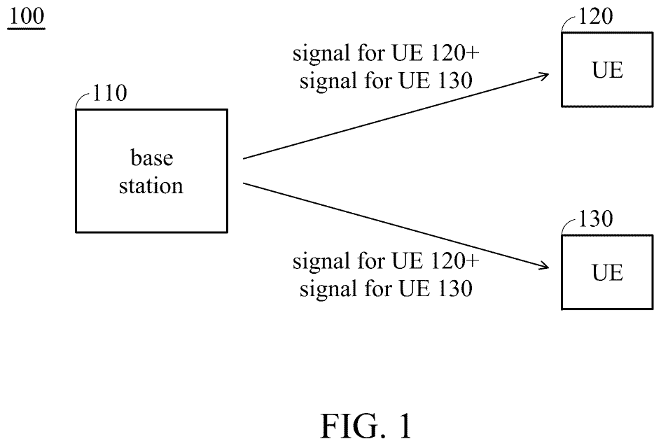

FIG. 1 shows a schematic diagram of a communication system 100 in accordance to embodiments of the present disclosure. The communication system 100 includes a base station 110, a user equipment (UE) 120, and a UE 130. The UE 120 and the UE 130 communicate with the base station 110 in a MU-MIMO manner. The UE 120 and the UE 130 may connect to a network (such as Internet) through the base station 110. The UE 120 and the UE 130 support reduced complexity maximum likelihood (R-ML) receiver. The base station 110 schedules the data for the UE 120 together with the data for the UE 130. The base station 110 transmits the signal for the UE 120 and the signal for the UE 130 to the UE 120 and the UE 130 concurrently. In other words, the signal for the UE 120 and the signal for the UE 130 are overlapped with each other, and the UE 120 receives the overlapped signal. Thus, the UE 120 and the UE 130 is a co-scheduled UE for each other. For the UE 120, first, the UE 120 has to demodulation/decode the signal for the UE 130 (i.e. the co-scheduled UE). Then, the UE 120 subtracts the signal for the UE 130 from the received overlapped signal to obtain the signal for the UE 120.

To demodulate the signal for the co-scheduled UE, the UE 120 needs the following information or parameters: the scrambling identifier of the co-scheduled UE, the time and frequency resources occupied by the co-scheduled UE, the modulation order used by the co-scheduled UE, and the MIMO layer used by the co-scheduled UE. The scrambling identifier indicates which scrambling code is used in the signal. The modulation order indicates which modulation type is being used in the signal, such as but not limited to 8 phase-shift keying (PSK), 16 PSK, 32 PSK, 32 quadrature amplitude modulation (QAM), 64 QAM, and 128 QAM. The MIMO layer indicates the number of independent data streams simultaneously received by the UE. In some embodiments, the UE 120 is able to detect these parameters on its own, such as by performing blind detection. In other embodiments, the UE 120 is unable to detect these parameters and requires the base station 110 to provide theses parameters. In some embodiments, the base station 110 informs the UE 120 these parameters using a downlink control information (DCI), a media access control (MAC) control element (CE), a radio resource configuration (RRC) signaling, or the combination thereof. Thus, in some embodiments, the UE 120 may inform the base station 110 whether the UE 120 requires the base station to provide the parameters of the co-scheduled UE. By doing so, the base station 110 can determine whether to transmit the parameters of the co-scheduled to the UE 110 and thus reduce the waste of downlink transmission resources.

It should be noted that although FIG. 1 only shows two UEs, there may be more than two UEs in the communication system 100 (i.e. there may be more than one co-scheduled UE).

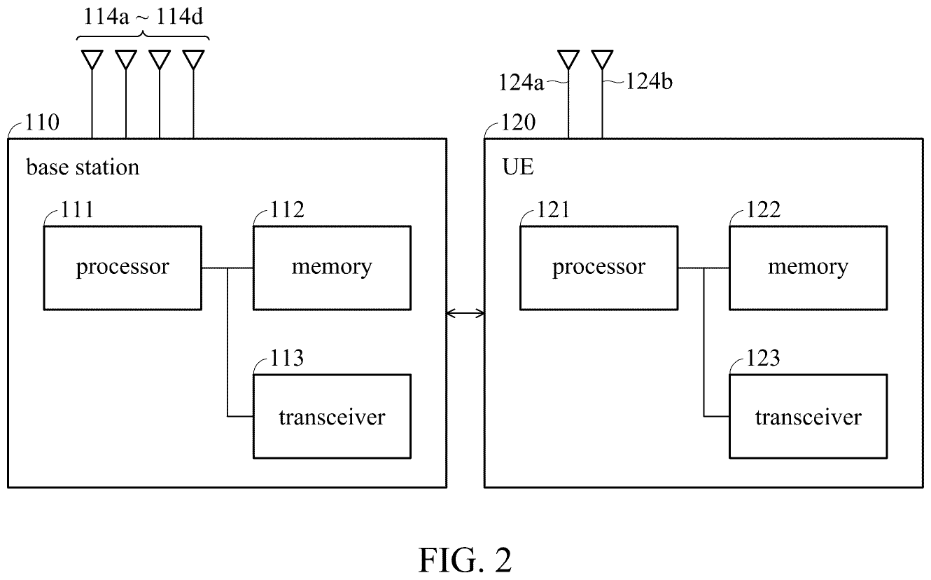

FIG. 2 shows a block diagram of the base station 110 and the UE 120 according to the embodiments of the present disclosure. The UE 130 may be similar to the UE 120 and won't be detailed described below. The base station 110, the UE 120, and the UE 130 may perform various functions to implement processes and methods described herein. For example, the base station 110 may be an access point, an access terminal, an evolved Node-B (eNB), or a gNodeB (gNB). The UE 120 may be a mobile apparatus, a wearable apparatus, a wireless communication apparatus, or a computing apparatus. In some embodiments, the UE 120 is implemented in a smartphone, a smartwatch, a tablet computer, or a notebook computer. Both the base station 110 and the UE 120 may be implemented in the form of one or more integrated-circuit (IC) chips such as, one or more processors. The base station 110 includes a processor 111, a memory 112, a transceiver 113, and antennas 114a~114d. The UE 120 includes a processor 121, a memory 122, a transceiver 123, and antennas 124a and 124b.

The processors 111 and 121 respectively control operations of the base station 110 and the UE 120. The processors 111 and 121 provide the required process ability to perform operating systems, programs, software, modules, applications, and functions of the base station 110 and the UE 120. In some embodiments, the processors 111 and 121 may be implemented in the form of hardware with electronic components including transistors, diodes, capacitors, resistors, or inductors. These components are configured to achieve specific purposes in accordance with the present disclosure. Thus, the processors 111 and 121 are special-purpose machine specifically configured to perform specific tasks including method of the present disclosure. For example, the processors 111 and 121 may be general-purpose micro-processors, central processing units, the combination of the general-purpose processor and special purpose processor, and/or related chip set.

The memories 112 and 122 store data required by the processors 111 and 121, respectively. The memories 112 and 122 may include non-volatile memories, such as read only memory (ROM) and flash memory. The memories 112 and 122 may also include volatile memories, such as dynamic random access memory (DRAM) and static random access memory (SRAM). In some embodiments, the memories 112 and 122 store programs, such as computer-readable instructions. The programs can be operated by the processors 111 and 121. When the programs are operated by the processors 111 and 121, the programs cause the processors 111 and 121 to implement methods according to the embodiments of the present disclosure.

The transceivers 113 and 123 are capable to transmit and receive data wirelessly. The transceiver 113 is coupled with the antennas 114a~114d, and the transceiver 123 is coupled with the antennas 124a and 124b. The transceivers 113 and 123 receives radio frequency (RF) signals from the antennas and converts the RF signals to baseband signals. The transceiver 230 also converts the baseband signals to the RF signals and sends out the RF signals through the antennas. The transceiver 123 includes an R-ML receiver.

It should be noted that the base station 110 and the UE 120 may have any number of antennas. Moreover, the base station 110 may communicates with the UEs 120 and 130 applying any possible MIMO settings. For example, the connection between the base station 110 and the UE 120 may employ a 2×2 MIMO scheme, and the connection between the base station 110 and the UE 130 may employ a 2×2 MIMO scheme. Alternatively, the connection between the base station 110 and the UE 120 may employ a 4×2 MIMO scheme, and the connection between the base station 110 and the UE 130 may also employ a 4×2 MIMO scheme.

Moreover, the base station 110 and the UE 120 may also include other components which aren't shown in FIG. 2. For example, the base station 110 and the UE 120 may also include, or wired/wirelessly connect to, at least one power supplier, monitor, touch screen, keyboard, mouse, microphone, and/or speaker etc.

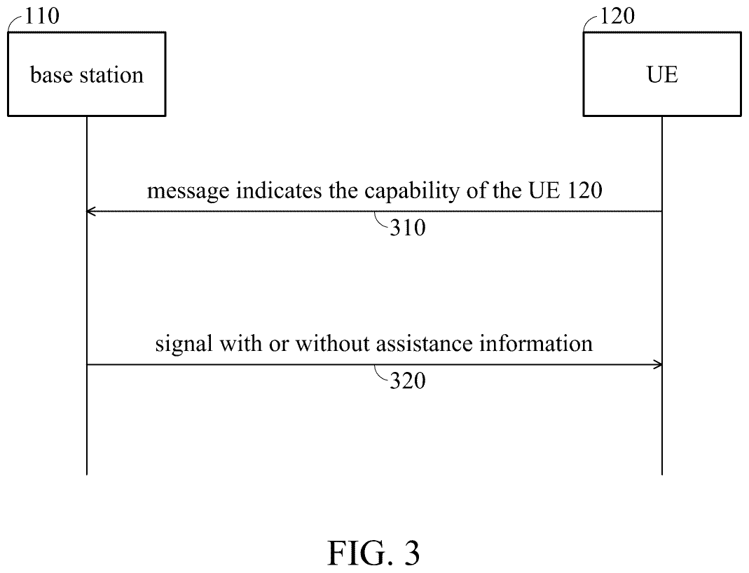

FIG. 3 shows a flow diagram of a method 300 of wireless communication in accordance to the embodiments of the present disclosure. Method 300 can be performed by the UE 120 (or the UE 130) in the communication system 100 of FIG. 1. Method 300 is described below in reference to FIGS. 1 and 2. Method 300 may start from operation 310. In operation 310, the UE 120 transmits a message to the base station 110 through the transceiver 123. In some embodiments, the UE 120 indicates its capabilities in the MU-MIMO communication system using the message. In some embodiments, the message indicates that the UE 120 supports MU-MIMO R-ML receiver. In some embodiments, the processor 121 is configured to determine whether the UE 120 supports (e.g. equipped with) the MU-MIMO R-ML receiver. In some embodiments, the message further indicates whether the UE 120 requires the base station 110 to provide parameters of the UE 130 (i.e. the co-scheduled UE). The parameters of the UE 130 are the scrambling identifier of the UE 130, time and frequency resources of the UE 130, a modulation order of the UE 130, and a MIMO layer of the UE 130.

In some embodiments, the messages indicates that the UE 120 doesn't require the base station 110 to provide the parameters of the UE 130, when the UE 120 is able to detect the parameters of the UE 130 on its own. Then, the UE 120 detects the parameters of the UE 130 in order to demodulate the signal for the UE 130 and its own signal. In some embodiments, the UE 120 uses energy detection and/or some other algorithms to detect the parameters of the UE 130. In some embodiments, the processor 121 is configured to determine whether the UE 120 is able to detect the parameters of the co-scheduled UE (e.g. according to the hardware configuration and/or the process capabilities of the UE 120). In some embodiments, the UE 120 may determine that at least one of the parameters is identical between the UE 120 and the UE 130.

In some embodiments, the UE 120 obtains a pre-defined configuration from the base station 110, and the pre-defined configuration indicates that at least one of the parameters is identical between the UE 120 and the UE 130. In these embodiments, the UE 120 only needs to detect the parameters other than the identical one (i.e. the parameters those are different between the UE 120 and 130). For example, the pre-defined configuration may indicate that the UE 120 and the UE 130 are configured with the same scrambling ID. Thus, the UE 120 does not detect the scrambling ID of the UE 130 and detects the parameters of the UE 130 other than the scrambling ID (i.e. time and frequency resources of the UE 130, a modulation order of the UE 130, and a MIMO layer of the UE 130).

In some embodiments, the messages indicate that the UE 120 requires the base station 110 to provide the parameters of the UE 130, when the UE 120 is unable to detect the parameters of the UE 130 on its own. In some embodiments, the UE 120 may determine that at least one of the parameters is identical between the UE 120 and the UE 130. In some embodiments, the UE 120 obtains a pre-defined configuration from the base station 110, and the pre-defined configuration indicates that at least one of the parameters is identical between the UE 120 and the UE 130. In these embodiments, the UE 120 informs the base station 110 that the UE requires the base station 110 to provide a parameter other than the identical one (i.e. the parameters which are different between the UE 120 and 130) in the message. In other words, the message may further indicate which parameter does the UE 120 require the base station 110 to provide. For example, the pre-defined configuration may indicate that the UE 120 and the UE 130 are configured with the same scrambling ID. Thus, the UE 120 informs the base station 110 to provide parameters other than the scrambling ID (i.e. time and frequency resources of the UE 130, a modulation order of the UE 130, and a MIMO layer of the UE 130).

In operation 320, the UE 120 receives the signal from the base station 110. As mentioned above, the base station 110 schedules the data for the UE 120 together with the data for the UE 130, and the signal for the UE 120 and the signal for the UE 130 are overlapped with each other. In some embodiments, the UE 120 also receives the parameters of the UE 130 from the base station 110, when the message indicates that the UE 120 requires the base station 110 to provide parameters of the UE 130. In some embodiments, the signal received from the base station 110 may contain assistance information, which indicates the parameters of the UE 130. In some embodiments, the base station 110 transmits the assistance information to the UE 120 using a DCI, a MAC CE, a RRC signaling, or the combination thereof. In some embodiments, the signal received from the base station 110 may not contain the parameters of the UE 130, when the message indicates that the UE 120 does not require the base station 110 to provide parameters of the UE 130.

In some embodiments, the UE 120 transmits the message to the base station 110 (operation 310) before communicating with the base station 110 in a MU-MIMO manner. The base station 110 determines to transmit signals to the UE 120 and 130 in the MU-MIMO manner (operation 320), after receiving the message from the UE 120.

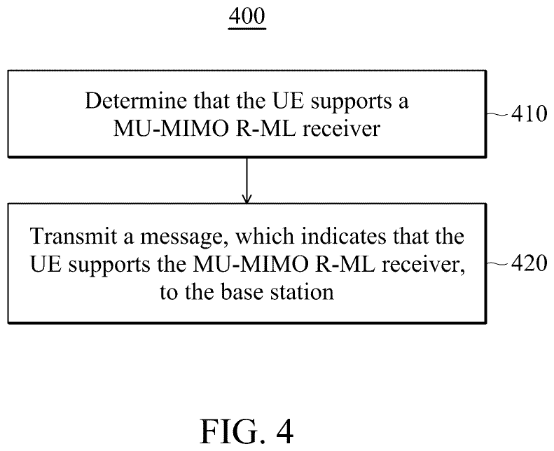

FIG. 4 shows a flow diagram of a method 400 of wireless communication in accordance to the embodiments of the present disclosure. Method 400 can be performed by the UE 120 (or the UE 130) in the communication system 100 of FIG. 1. Method 400 is described below in reference to FIGS. 1 and 2. Method 400 may start from operation 410. In operation 410, the processor 121 of the UE 120 determines that the UE 120 supports a MU-MIMO R-ML receiver. In operation 420, the UE 120 transmits a message to the base station 110 through the transceiver 123. The message indicates that the UE 120 supports the MU-MIMO R-ML receiver.

In the embodiments of the present disclosure, the UE can inform the base station its capabilities. The base station can determine whether to provide additional information (such as assistance information) to the UE based on the capabilities of the UE. Thus, embodiments of the present disclosure can avoid transmitting unnecessary in formation and thus serve resources.

While the invention has been described by way of example and in terms of the preferred embodiments, it should be understood that the invention is not limited to the dis-closed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of wireless communication, comprising:
determining, via a user equipment (UE), that the UE supports a multi-user multiple-input multiple-output (MU-MIMO) reduced-complexity maximum-likelihood (R-ML) receiver; and
transmitting, via the UE, a message to a base station;
wherein the message indicates that the UE supports the MU-MIMO R-ML receiver.

2. The method as claimed in claim 1, wherein the message further indicates whether the UE requires the base station to provide parameters of a co-scheduled UE;
wherein the UE and the co-scheduled UE communicate with the base station in a MU-MIMO manner.

3. The method as claimed in claim 2, further comprising:
informing the base station that the UE doesn't require the base station to provide the parameters of the co-scheduled UE using the message, when the UE is capable of detecting the parameters of the co-scheduled UE.

4. The method as claimed in claim 2, further comprising:
informing the base station that the UE requires the base station to provide the parameters of the co-scheduled UE using the message, when the UE isn't capable of detecting the parameters of the co-scheduled UE.

5. The method as claimed in claim 4, further comprising:
receiving, via the UE, an assistant information which indicates the parameters of the co-scheduled UE from the base station.

6. The method as claimed in claim 2, further comprising:
determining, via the UE, that at least one of the parameters is identical between the UE and the co-scheduled UE; and
informing, via the UE, the base station that the UE requires the base station to provide the parameter other than the identical one; or
detecting, via the UE, the parameter other than the identical one.

7. The method as claimed in claim 2, wherein the parameters are a scrambling identifier of the co-scheduled UE, time and frequency resources of the co-scheduled UE, a modulation order of the co-scheduled UE, and a MIMO layer of the co-scheduled UE.

8. The method as claimed in claim 2, wherein the UE transmits the message to the base station before communicating with the base station in a MU-MIMO manner.

9. A user equipment (UE), comprising:
a processor; and
a transceiver,
wherein the processor is configured to:
determine that the UE supports a multi-user multiple-input multiple-output (MU-MIMO) reduced-complexity maximum-likelihood (R-ML) receiver; and
transmit a message to a base station through the transceiver;
wherein the message indicates that the UE supports the MU-MIMO R-ML receiver.

10. The UE as claimed in claim 9, wherein the message further indicates whether the UE requires the base station to provide parameters of a co-scheduled UE;
wherein the UE and the co-scheduled UE communicate with the base station in a MU-MIMO manner.

11. The UE as claimed in claim 10, wherein the processor is further configured to:
inform the base station that the UE doesn't require the base station to provide the parameters of the co-scheduled UE using the message, when the UE is capable of detecting the parameters of the co-scheduled UE.

12. The UE as claimed in claim 10, wherein the processor is further configured to:
inform the base station that the UE requires the base station to provide the parameters of the co-scheduled UE using the message, when the UE isn't capable of detecting the parameters of the co-scheduled UE.

13. The UE as claimed in claim 12, wherein the processor is further configured to:
receive an assistant information which indicates the parameters of the co-scheduled UE from the base station through the transceiver.

14. The UE as claimed in claim 10, wherein the processor is further configured to:
determine that at least one of the parameters is identical between the UE and the co-scheduled UE; and
inform the base station that the UE requires the base station to provide the parameter other than the identical one; or
detect the parameter other than the identical one.

15. The UE as claimed in claim 10, wherein the parameters are a scrambling identifier of the co-scheduled UE, time and frequency resources of the co-scheduled UE, a modulation order of the co-scheduled UE, and a MIMO layer of the co-scheduled UE.
